(19) United States
(12) Patent Application Publication
(10) Pub. No.: US 2025/0078565 A1
(43) Pub. Date: Mar. 6, 2025

(54) Processing of Facial Data Through Bi-Optic Pipeline

(71) Applicant: ZEBRA TECHNOLOGIES CORPORATION, Lincolnshire, IL (US)

(72) Inventors: Christopher W. Brock, Manorville, NY (US); Yuri Astvatsaturov, Lake Forest, IL (US)

(21) Appl. No.: 18/242,123

(22) Filed: Sep. 5, 2023

(51) Int. Cl. G06V 40/16; G06K 7/10; G06V 10/82

(52) U.S. Cl. CPC G06V 40/169; G06K 7/1092; G06V 10/82

(57) ABSTRACT

Systems and methods for anonymizing image data are disclosed herein. An example implementation includes: capturing, with an indicia reader, an image data of a field of view (FOV) associated with an imager within the indicia reader; determining, with the indicia reader, a facial area within the image data; producing, with the indicia reader, an anonymized image data by altering pixel data of the facial area of the image data; and (i) storing the anonymized image data in a nonvolatile memory of the indicia reader, or (ii) transmitting the anonymized image data from the indicia reader to one or more host processors.

### BACKGROUND

Current indicia decoding systems (e.g., barcode decoding systems) operate by capturing an image, and then decoding an indicia in the image. However, depending on the application, there may be a need to process image data received from indicia readers in novel ways. Accordingly, there is a need for new and improved methods, devices, and systems associated with indicia decoders, which implement such image processing.

### SUMMARY

In an embodiment, the present invention is a method for anonymizing image data. The method may comprise: capturing, with an indicia reader, an image data of a field of view (FOV) associated with an imager within the indicia reader; determining, with the indicia reader, a facial area within the image data; producing, with the indicia reader, an anonymized image data by altering pixel data of the facial area of the image data; and (i) storing the anonymized image data in a nonvolatile memory of the indicia reader, or (ii) transmitting the anonymized image data from the indicia reader to one or more host processors.

In a variation of this embodiment, the altering the pixel data comprises: (i) removing color data of the pixel data, or (ii) replacing the color data of the pixel data with color data of a predetermined color.

In another variation of this embodiment, the altering the pixel data comprises: (i) changing an intensity of the pixel data, or (ii) replacing pixel data to create an anonymizing graphic.

In another variation of this embodiment, the determining the facial area comprises determining at least one facial feature within the facial area.

In a variation of this embodiment, between the capturing of the image data and the storing or transmitting the anonymized image data, the image data is not put through at least one of a facial-recognition module or person-recognition module configured to provide information related to an identify of an individual.

In another variation of this embodiment, the determining the facial area comprises applying a predetermined pixel area around a determined location of the at least one facial feature.

In another variation of this embodiment, the determining the facial area comprises determining an outline of a person within the image data, and determining the facial area based on a predetermined positional relationship of the facial area to the outline.

In another variation of this embodiment, the determining the facial area comprises determining a non-facial feature associated with a human body within the image data, and determining the facial area to be an area positioned at a predetermined positional relationship relative to the non-facial feature.

In another variation of this embodiment, the determining the facial area comprises: (i) applying a localizer comprising a neural network to impose a bounding box surrounding an object in the image data, and (ii) analyzing a portion of the image data outside of the bounding box to determine the facial area.

In another variation of this embodiment, the image data is: (i) pre-anonymized image data received from the imager within the indicia reader, and (ii) not stored on the nonvolatile memory of the indicia reader.

In another variation of this embodiment, the image data in at least one volatile memory of the indicia reader to execute the determining the facial area and the producing the anonymized image data.

In another embodiment, the present invention is an imaging engine comprising one or more processors configured to: capture an image data of the FOV; determine a facial area within the image data; produce an anonymized image data by altering pixel data of the facial area of the image data; and (i) store the anonymized image data in a nonvolatile memory of the indicia reader, or (ii) transmit the anonymized image data from the indicia reader to one or more host processors.

In a variation of this embodiment, the altering the pixel data comprises: (i) removing color data of the pixel data, or (ii) replacing the color data of the pixel data with color data of a predetermined color.

In another variation of this embodiment, the altering the pixel data comprises: (i) changing an intensity of the pixel data, or (ii) replacing pixel data to create an anonymizing graphic.

In another variation of this embodiment, the determine the facial area comprises determining at least one facial feature within the facial area.

In another variation of this embodiment, the one or more processors are further configured to: between the capture of the image data and the store or transmit the anonymized image data, not put the image data through at least one of a facial-recognition module or person-recognition module configured to provide information related to an identify of an individual.

In a variation of this embodiment, the determine the facial area comprises applying a predetermined pixel area around a determined location of the at least one facial feature.

In another variation of this embodiment, the determine the facial area comprises determining an outline of a person within the image data, and determining the facial area based on a predetermined positional relationship of the facial area to the outline.

In another variation of this embodiment, the determine the facial area comprises determining a non-facial feature associated with a human body within the image data, and determining the facial area to be an area positioned at a predetermined positional relationship relative to the non-facial feature.

In another variation of this embodiment, the determine the facial area comprises: (i) applying a localizer comprising a neural network to impose a bounding box surrounding an object in the image data, and (ii) analyzing a portion of the image data outside of the bounding box to determine the facial area.

In another variation of this embodiment, (i): the image data is pre-anonymized image data received from the imager within the indicia reader, and (ii) the one or more processors are further configured to not store the pre-anonymized image data on the nonvolatile memory of the indicia reader.

In another variation of this embodiment, the one or more processors are further configured to store the image data in at least one volatile memory of the indicia reader to execute the determine the facial area and the producing the anonymized image data.

In another embodiment, the present invention is an indicia reader, comprising: an imaging assembly configured to capture image data of an environment appearing in a field of view (FOV); a housing including a tower, a platter, and the imaging assembly; and a non-transitory computer-readable media. The non-transitory computer-readable media storing machine-readable instructions that, when executed, may cause the indicia reader to: capture an image data of the FOV; determine a facial area within the image data; produce an anonymized image data by altering pixel data of the facial area of the image data; and (i) store the anonymized image data in a nonvolatile memory of the indicia reader, or (ii) transmit the anonymized image data from the indicia reader to one or more host processors.

In a variation of this embodiment, the machine-readable instructions, when executed, further cause the indicia reader to: receive a disable anonymizer feature command; and responsive to receiving the disable anonymizer feature command, enable: (i) storing of the image data in the nonvolatile memory of the indicia reader, or (ii) transmission of the image data from the indicia reader to the one or more host processors.

In another variation of this embodiment, the machine-readable instructions, when executed, further cause the indicia reader to: prior to the produce of the anonymized image data, attempt to identify an indicia in a non-facial area of the image data; and if the indicia is not identified in the non-facial area, attempt to identify the indicia in an area of the image data including both the non-facial area and the facial area.

In another variation of this embodiment, the FOV is a tower FOV extending horizontally from the tower, and the imaging assembly is further configured to capture a platter FOV extending vertically from the platter; and the machine-readable instructions, when executed, further cause the indicia reader to: capture platter image data of the platter FOV; determine a facial area within the platter image data; produce an anonymized platter image data by altering pixel data of the facial area of the platter image data; and (i) store the anonymized platter image data in a nonvolatile memory of the indicia reader, or (ii) transmit the anonymized platter image data from the indicia reader to the one or more host processors.

In another variation of this embodiment, the altering the pixel data comprises: (i) removing color data of the pixel data, or (ii) replacing the color data of the pixel data with color data of a predetermined color.

In another variation of this embodiment, the altering the pixel data comprises: (i) changing an intensity of the pixel data, or (ii) replacing pixel data to create an anonymizing graphic.

In another variation of this embodiment, the determine the facial area comprises determining at least one facial feature within the facial area.

In another variation of this embodiment, the machine-readable instructions, when executed, further cause the indicia reader to: between the capture of the image data and the store or transmit the anonymized image data, not put the image data through at least one of a facial-recognition module or person-recognition module configured to provide information related to an identify of an individual.

In another variation of this embodiment, the determine the facial area comprises applying a predetermined pixel area around a determined location of the at least one facial feature.

In another variation of this embodiment, the determine the facial area comprises determining an outline of a person within the image data, and determining the facial area based on a predetermined positional relationship of the facial area to the outline.

In another variation of this embodiment, the determine the facial area comprises determining a non-facial feature associated with a human body within the image data, and determining the facial area to be an area positioned at a predetermined positional relationship relative to the non-facial feature.

In another variation of this embodiment, the determine the facial area comprises: (i) applying a localizer comprising a neural network to impose a bounding box surrounding an object in the image data, and (ii) analyzing a portion of the image data outside of the bounding box to determine the facial area.

In another variation of this embodiment, (i): the image data is pre-anonymized image data received from the imager within the indicia reader, and (ii) the machine-readable instructions, when executed, further cause the indicia reader to not store the pre-anonymized image data on the nonvolatile memory of the indicia reader.

In another variation of this embodiment, the machine-readable instructions, when executed, further cause the indicia reader to store the image data in at least one volatile memory of the indicia reader to execute the determine the facial area and the producing the anonymized image data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example imaging system for anonymizing image data, in accordance with embodiments described herein.

FIG. 2 illustrates an isometric view of indicia reading platform, in accordance with some embodiments described herein.

FIG. 3 depicts an example image including an object with an indicia, and further including a person's face.

FIG. 4 is a flowchart representative of a method for anonymizing an image, in accordance with embodiments described herein.

FIG. 5 shows an example person including an example outline of the person, example facial features, and example non-facial features.

FIG. 6 shows an example person whose face has been replaced with an anonymizing graphic of a lion head.

FIG. 7 shows an example imaging assembly.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

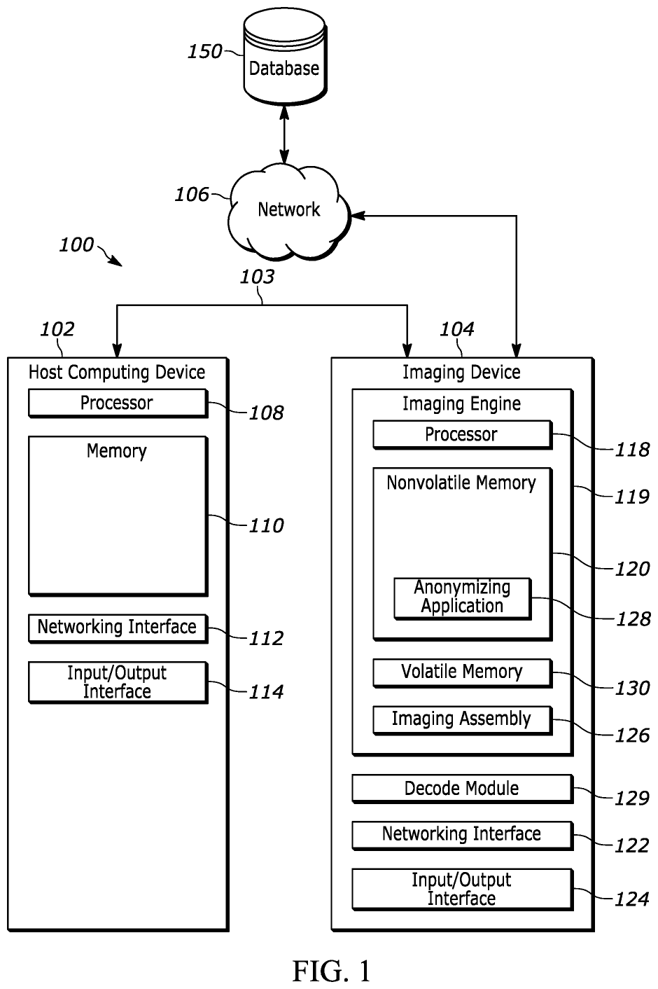

Broadly speaking, some embodiments described herein provide for anonymizing image data captured from an indicia reader. For example, by way of reference to FIG. 1, an imaging device 104 (e.g., an indicia reader, such as a bi-optic reader, a slot scanner, an in-counter scanner, a handheld reader, a hands-free reader, etc.) may capture image data (e.g., pre-anonymized image data). The image data may include an indicia which is able to be decoded (e.g., via the decode module 129) to determine the full payload thereof. As described herein, an indicia may mean a visual feature that encodes a payload, where the payload can be extracted by a decode module that processes image data associated with the indicia. In various examples, indicia can include a 1D barcode, a 2D barcode, a direct part mark (DPM) code, a dot matric code, a quick response (QR) code, etc.

However, in some situations, the captured image may also include a depiction of a person's face. In some instances, it has been identified that the facial data should not be stored, processed, and/or transmitted downstream to the host computing device 102. To address these instances and others, the techniques described herein allow for systems to, among other operations, decode an indicia in captured image data, while not retaining identifying information of a person also captured in that image data.

To this end, FIG. 1 illustrates an example imaging system 100 configured to anonymize image data, in accordance with various embodiments disclosed herein. In the example embodiment of FIG. 1, the imaging system 100 includes the host computing device 102 and the imaging device 104 communicatively coupled to the host computing device 102 via a link 103 (e.g., a bus; a cable; a wireless connection; circuitry, such as when the imaging device 104 is implemented inside a mobile device, etc.; etc.). Generally speaking, the host computing device 102 and the imaging device 104 may be capable of executing instructions to, for example, implement operations of the example methods described herein, as may be represented by the flowcharts of the drawings that accompany this description. For instance, the host computing device 102 may be connected to the imaging device 104 via a link 103, and may generally be configured to interpret and process information received from the imaging device 104. For example, the imaging device 104 may decode indicia via the decode module 129, and then send the payload to the host computing device 102.

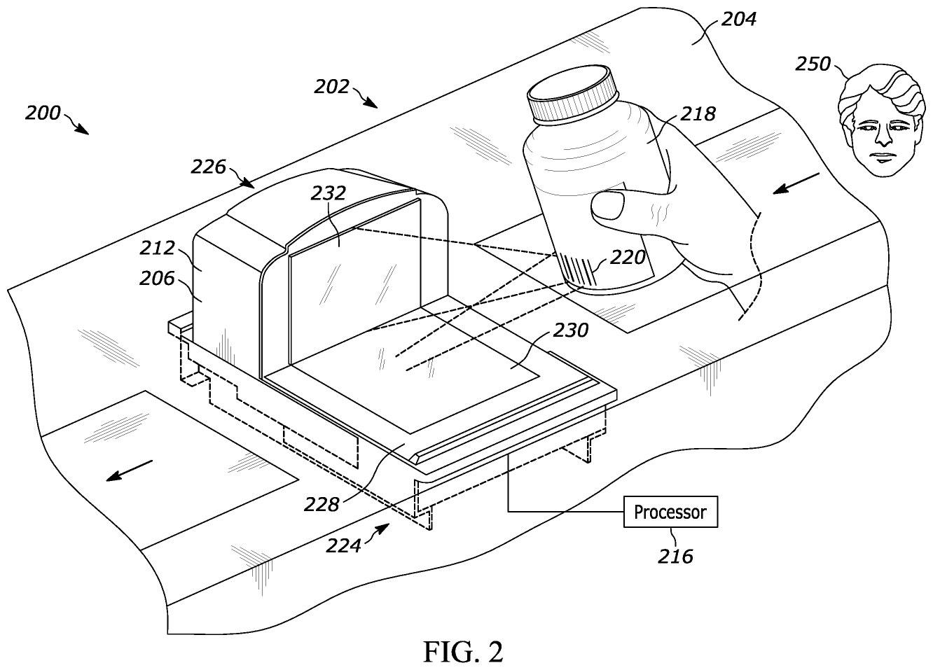

The imaging device 104 may be any suitable device to capture image data, such as a handheld indicia reader, mounted indicia reader, or bi-optic (also referred to as “bi-optical”) indicia reader (such as the example indicia reader 200 of FIG. 2, which will be described further below), for example. In some examples, the imaging device 104 may be a machine vision camera.

The imaging device 104 may include imaging engine 119. In some embodiments, the imaging engine 119 may be removable, and transferable between imaging devices 104. Broadly speaking, the imaging engine 119 may be used to capture and process image data. Once captured, an indicia in the image data may be decoded according to instructions stored by the decode module 129. In some embodiments, as illustrated in the example of FIG. 1, the decode module 129 is separate from the imaging engine 119. Advantageously, this allows reader manufacturers flexibility in attaching their own preferred decode module 129 to the imaging engine 119. However, in other embodiments, the imaging engine 119 may include the decode module 129. In still other embodiments (not shown in FIG. 1), the host computing device 102 may include a decode module, which may receive and decode the image data.

The imaging engine 119 may include one or more processors 118, one or more nonvolatile memories 120, one or more volatile memories 130, an imaging assembly 126, and anonymizing application 128. The imaging assembly 126 may include multiple sub-assemblies utilizing digital imagers configured to capture image data suitable for various purposes. For example, one sub-assembly may be configured to capture images suitable for indicia decoding by a decode module while another sub-assembly may be configured to capture image data suitable for vision analysis like object recognition and tracking.

Each digital image may comprise pixel data that may be analyzed in accordance with instructions comprising the anonymizing application 128, as executed by the one or more processors 118, as described herein. The digital imager and/or digital video imager of, e.g., the imaging assembly 126 may be configured to take, capture, or otherwise generate digital images. In some embodiments, the digital images may comprise pre-anonymized image data and may be initially stored in the volatile memory 130. In some embodiments, the pre-anonymized image data is then anonymized (as will be described in further detail elsewhere herein, e.g., by the anonymizing application 128), and then stored in the nonvolatile memory 120 and/or transmitted to the host computing device 102.

Advantageously, initially storing the pre-anonymized image data in the volatile memory 130, then anonymizing the data, and finally storing the anonymized data on the nonvolatile memory 120 (or memory 110, which may be nonvolatile or volatile memory) prevents a person's facial features from being stored on the nonvolatile memory 120, thereby enhancing privacy, and compliance with potential regulations.

However, not all image data must to go through the anonymizing application 128. For example, image data may be selectively anonymized based on what purposes it will be used for. In this way, if one imager is performing data capture for both barcoding purposes and machine vision purposes, data that is fed to the decode module 129 may not have to go through the anonymizing process while data that is routed for vision analysis or storage would.

Along these lines, in some embodiments, image data from only a specific sub-assembly(ies) may be routed through the anonymizing application 128 while other data coming from other sub-assembly(ies) may not. For instance, data coming from the imaging assembly 126 used for decoding purposes may not have to go through the anonymizing application 128 while data from the machine vision imager may. However, in some embodiments, all data is routed through the anonymizing application 128.

In some examples, the imaging assembly 126 may include a photo-realistic imager (not shown) for capturing, sensing, or scanning 2D image data. The photo-realistic imager may be an RGB (red, green, blue) based imager for capturing 2D images having RGB-based pixel data. In various embodiments, the imaging assembly may additionally include a three-dimensional (3D) imager (not shown) for capturing, sensing, or scanning 3D image data. The 3D imager may include an Infra-Red (IR) projector and a related IR imager for capturing, sensing, or scanning 3D image data/datasets. In some embodiments, the photo-realistic imager of the imaging assembly 126 may capture 2D images, and related 2D image data, at the same or similar point in time as the 3D imager of the imaging assembly 126 such that the imaging device 104 can have both sets of 3D image data and 2D image data available for a particular surface, object, area, or scene at the same or similar instance in time. In various embodiments, the imaging assembly 126 may include the 3D imager and the photo-realistic imager as a single imaging apparatus configured to capture 3D depth image data simultaneously with 2D image data. Consequently, the captured 2D images and the corresponding 2D image data may be depth-aligned with the 3D images and 3D image data.

In some embodiments, the imaging assembly 126 may include a single sensor/lens, and in other embodiments, the imaging assembly 126 may include multiple sensors/lenses. Moreover, the image data collected by the sensor(s) of the imaging assembly may be routed to different modules. Advantageously, this allows for a first sensor/lens pair to capture images fed to the decode module 129, and a second sensor/lens pair to send vision data for other vision purposes. This is advantageous because images captured for decoding purposes do not have to have the same fidelity as those which are used for other vision purposes (e.g., grayscale images coming from a lower-resolution sensor for decoding purposes verses colored images coming from a relatively high-resolution sensor for vision purposes). In some embodiments, the same imaging assembly 126 captures image data for both decoding purposes and machine vision purposes.

FIG. 7 illustrates one example imaging assembly 126 (e.g., optical imaging assembly 700). More particularly, in the illustrated example, the optical imaging assembly 700 includes a rolling shutter image sensor 702 (also referred to as an imaging sensor or an imager) together with an imaging lens assembly 704 that focuses and directs light over a predefined field of view (FOV) 706 onto the image sensor 702. To help capture images of sufficient quality, the imaging devices may be further equipped with illumination assemblies 708 which commonly include an illumination source 710 and an illumination lens 712. The illumination source 710 may be implemented as any source (e.g., an LED source) operative to produce light that can illuminate an appropriate portion of the FOV 706 and provide sufficient light during image capture. In this manner, at least some light emitted by the illumination source away from the imaging apparatus will reflect off an object 714 being imaged and will be reflected by said object onto the imager 702, helping create a sufficiently illuminated image for various purposes, like indicia decoding. Additionally, the illumination source 710 may be controlled to operate in accordance with various operating characteristics, particularly as outlined further in this disclosure.

These imaging components may be housed behind a window 716 (e.g., window 232) and operate over some working range defined by a near working range WD1 and a far working range WD2. Range limits WD1 and WD2 may depend on the focusing capabilities of the imaging optics, the resolution of the image sensor, and/or the illumination characteristics.

The imaging assembly 700 and illumination source 710 may be positioned on same (or separate) printed circuit board 718 and each one may be controlled via a controller 720 (e.g., processor 118) which is operatively connected to at least some components of each assembly. Controller 720 may be embodied in one or more microprocessors that includes one or more modules for conducting the control functions associated with the imaging assembly 700. The imaging assembly 700 may further be connected to a memory 722 (e.g., the volatile memory 130, or nonvolatile memory 120).

Furthermore, the example of FIG. 7 includes host computing device 799 (e.g., host computing device 102). As described elsewhere herein, the anonymization may be done at the controller 720 prior to storage at the host computing device 799. In addition, it should be understood that the imaging assembly 700, the controller 720, and memory 722 may be comprised in an imaging engine, such as imaging engine 119. Moreover, as mentioned elsewhere herein, the imaging engine may be transferrable between imaging devices, such as mobile devices.

The imaging device 104 may also process the 2D image data/datasets and/or 3D image datasets for use by other devices (e.g., the host computing device 102, an external server, etc.). For example, either before or after the image data is anonymized, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. In some embodiments, the image data and/or the post-imaging data may be sent to a server for storage or for further manipulation. As described herein, the host computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

The one or more nonvolatile memories 120 may include one or more forms non-volatile, fixed and/or removable memory, such as magnetic random-access memory (MRAM), ferroelectric random-access memory (FeRAM), phase-change memory (PCM), resistive random-access memory (RRAM), read-only memory (ROM), electronic programmable read-only memory (EPROM), erasable electronic programmable read-only memory (EEPROM), other hard drives, MicroSD cards, flash memory, etc.

The one or more volatile memories 130 may include one or more forms of volatile, fixed and/or removable memory, such as random-access memory (RAM), cache memory, etc.

The one or more memories 110 may be any suitable type of volatile and/or nonvolatile memory, and examples of the types include those discussed above with respect to the nonvolatile memory 120 and/or the volatile memory 130.

In general, a computer program or computer based product, application, or code (e.g., anonymizing application 128, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120, 130) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120, 130 may store an operating system (OS) (e.g., Microsoft Windows, Linux, Unix, etc.) capable of facilitating the functionalities, apps, methods, or other software as discussed herein. The one or more memories 110, 120, 130 may also store the anonymizing application 128. Additionally, or alternatively, the anonymizing application 128 may also be stored in the external database 150, which is accessible or otherwise communicatively coupled to the host computing device 102 via the network 106. The one or more memories 110, 120, 130 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the one or more processors 108, 118.

The one or more processors 108, 118 may be connected to the one or more memories 110, 120, 130 via a computer bus responsible for transmitting electronic data, data packets, or otherwise electronic signals to and from the one or more processors 108, 118 and one or more memories 110, 120, 130 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120, 130 via the computer bus to execute the operating system (OS). The one or more processors 108, 118 may also interface with the one or more memories 110, 120, 130 via the computer bus to create, read, update, delete, or otherwise access or interact with the data stored in the one or more memories 110, 120 and/or external database 150 (e.g., a relational database, such as Oracle, DB2, MySQL, or a NoSQL based database, such as MongoDB). The data stored in the one or more memories 110, 120, 130 and/or an external database 150 may include all or part of any of the data or information described herein, including, for example, visual embedding(s) corresponding to payloads (e.g., visual embedding(s) corresponding to barcodes or other indicia).

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120, 130 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally, or alternatively, network 106 may comprise a public network such as the Internet. In some embodiments, the network 106 may comprise routers, wireless switches, or other such wireless connection points communicating to the host computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the host computing device 102 and/or imaging device 104) which a user/operator may use to visualize any images, graphics, text, data, features, pixels, and/or other suitable visualizations or information. For example, the host computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the host computing device 102 and/or the imaging device 104. According to some embodiments, an administrator or user/operator may access the host computing device 102 and/or imaging device 104 to initiate imaging setting calibration, review images or other information, make changes, input responses and/or selections, and/or perform other functions.

As described above herein, in some embodiments, the host computing device 102 may perform the functionalities as discussed herein as part of a “cloud” network or may otherwise communicate with other hardware or software components within the cloud to send, retrieve, or otherwise analyze data or information described herein.

FIG. 2 illustrates a perspective view of an example scanning system 200 (e.g., an indicia reader that may be used in a retail environment) in accordance with the teachings of this disclosure. In the exemplary embodiment, the system 200 includes a workstation 202 with a counter 204 and a bi-optical (also referred to as “bi-optic”) indicia reader 206. Generally, the indicia reader 206 includes an upper housing 226 (also referred to as an upper portion, upper housing portion, or tower portion) and a lower housing 224 (also referred to as a lower portion, or lower housing portion). The upper housing 226 can be characterized by an optically transmissive window 232 positioned therein along a generally vertical plane and one or more field of view (FOV) which passes through the window 232 and extends in a generally lateral direction. The lower housing 224 can be characterized by a weigh platter 228 or a cover that includes an optically transmissive window 230 positioned therein along a generally horizontal (also referred to as a transverse) plane and one or more FOV which passes through the window 230 and extends in a generally upward direction. The weigh platter 210 is a part of a weigh platter assembly that generally includes the weigh platter 228 and a scale (or load cell) configured to measure the weight of an object placed the top surface of the weigh platter 228. By that virtue, the top surface of the weigh platter 228 may be considered to be the top surface of the lower housing 224 that faces a product scanning region there above. In some implementations, the bi-optic indicia reader 206 may include an IR sensor in addition to a number of imagers, such as an RGB imager(s) for machine vision imaging and/or monochrome imager(s) for capturing images for decoding purposes. It will be appreciated that a wide variety of color and/or monochrome image sensors may be used for the desired applications, and the respective parameters of these sensors may be selected and/or set in accordance with those applications. The scanning system 200 may be managed by a venue employee such as a clerk. In other cases, the scanning system 200 may be part of a self-checkout lane wherein customers are responsible for checking out their own products.

As should be appreciated, the purpose of the indicia reader 200 is to decode the indicia (e.g., barcode) 220 (e.g., via the processor 216). To decode the indicia 220, in some examples, the object 218 may be swiped past the indicia reader 206. In doing so, the indicia 220 associated with the object 218 is positioned within the platter FOV (e.g., an FOV of a sensor/lens pair within the platter 228) and/or tower FOV (e.g., an FOV of a sensor/lens pair within the tower 226).

However, an image captured to decode the indicia (or captured for another purpose, such as for machine vision purposes, etc.) may include a depiction of a human face 250 (e.g., the face of the customer scanning the object 218, or the face of a person standing nearby, etc.).

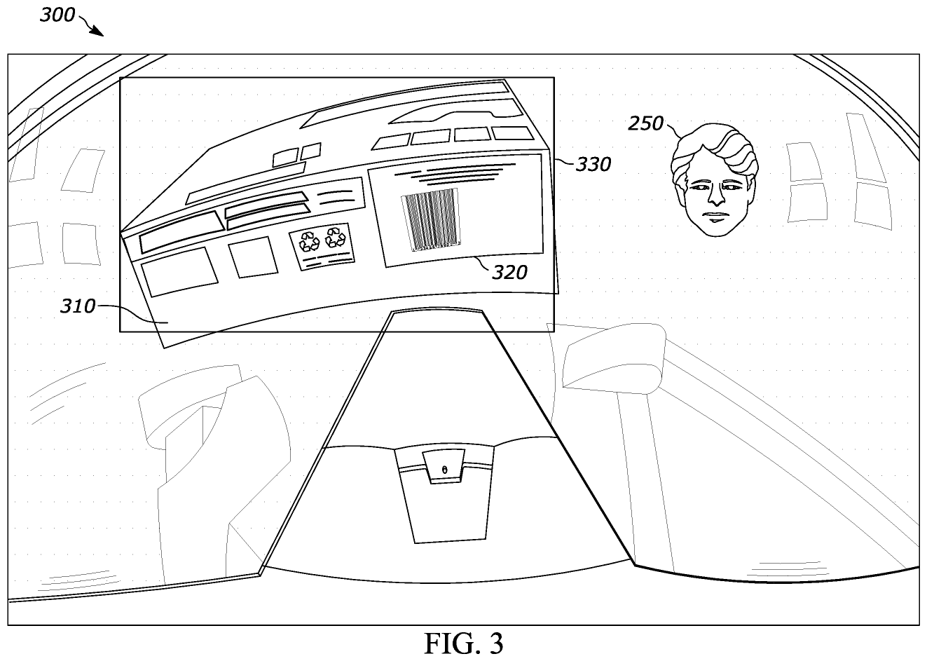

In one illustrative example, FIG. 3 shows an example image 300 including object 310, which, in the illustrated example, is a cereal box with indicia 320. The example image 300 also includes a depiction of a human face 250, which may have been inadvertently captured when capturing the example image 300. In addition, in the illustrated example, a localizer has placed a bounding box 330 around the object 310 as part of the process for decoding the indicia 320. In some examples, the localizer comprises a neural network trained to place bounding boxes around objects in images. Such a neural network may be trained by any suitable technique (e.g., a supervised learning process, an unsupervised learning process, a semi-supervised leaning process, etc.). Furthermore, it may be noted that displaying an image, such as the example image 300, is not necessary to perform the techniques described herein.

Some embodiments described herein address the need to remove facial data from the image by anonymizing the pre-anonymized image data (e.g., via the anonymizing application 128) before storing the image data on the nonvolatile memory 120.

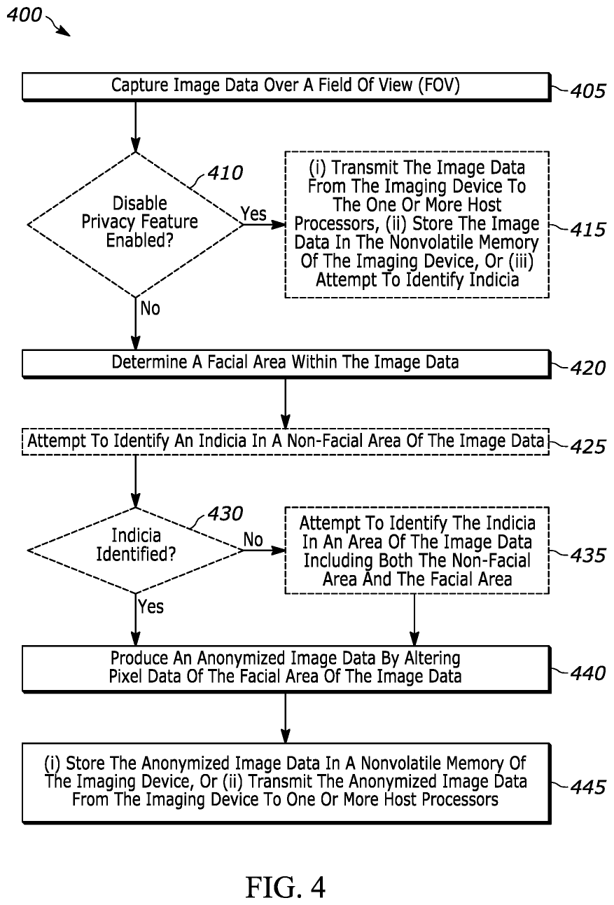

FIG. 4 illustrates an example method 400 for anonymizing image data. The example method 400 begins, at block 405, by capturing an image (e.g., pre-anonymized image data) with an imaging device 104 (e.g., via the imaging assembly 126, etc.). The image may be received at the host computing device 102 or the imaging device 104 (e.g., by anonymizing application 128, etc.). Furthermore, the image may include a face 250, object 218, an indicia 220, 320, and/or other visual features (e.g., an operator's hand, etc.).

In some embodiments, the imaging device 104 includes an option to enable or disable the anonymizer features. For example, the imaging device 104 may receive, via the I/O interface 124, a command to enable or disable the anonymizer features. Advantageously, this option to enable/disable the anonymizer features facilitates an operator using the imaging device 104 both in jurisdictions that may allow companies to retain identifying information, and in jurisdictions that may not allow companies to retain identifying information. In this regard, at optional decision block 410, the imaging device 104 checks if the anonymizer feature has been enabled (e.g., checks if the imaging device 104 is in a privacy mode or a non-privacy mode). If the anonymizer feature has not been enabled, the imaging device, at optional block 415: (i) transmits the image data from the imaging device 104 to the one or more host processors 108, (ii) stores the image data (e.g., the raw image data) in the nonvolatile memory 120 of the imaging device 104, or (iii) attempts to identify the indicia 220, 320. It should thus be appreciated, that if the anonymizer feature has not been enabled, the imaging device 104 proceeds normally (e.g., as a bi-optic indicia reader would that did not include privacy/anonymizer features) without anonymizing the image data.

If the anonymizer feature of the image has been enabled (e.g., the imaging device 104 is in a privacy/anonymizing mode), the processors executing the application may determine (at block 420) a facial area. In some embodiments, the facial area is only the area of the image that includes the face. In other embodiments, the facial area may include a part of the image that does not include the face. For example, the facial area may extend beyond the face by a predetermined number of pixels horizontally and/or a predetermined number of pixels vertically into the portion of the image that does not include the face.

In some embodiments, a neural network is applied (e.g., via the anonymizing application 128) to determine the face or facial area 250. Such a neural network may be trained by any suitable technique (e.g., a supervised learning process, an unsupervised learning process, a semi-supervised leaning process, etc.) to determine faces and/or facial areas.

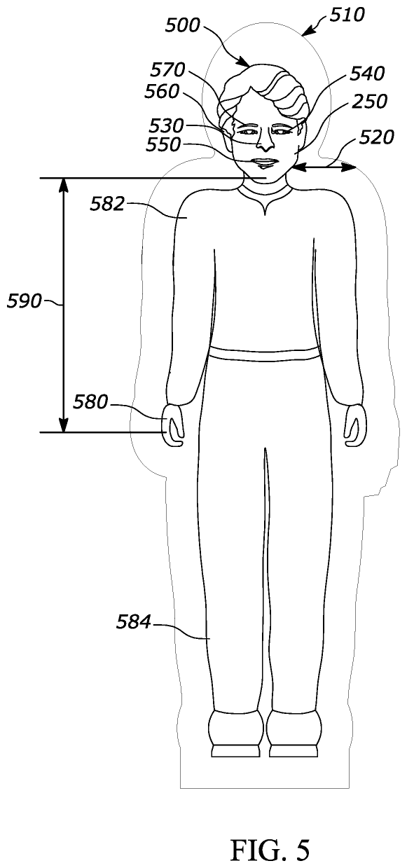

In some embodiments, as illustrated by the example of FIG. 5, the determination of the facial area 250 is accomplished by first determining an outline 510 of a person 500 within the image data, and then determining the facial area 250 based on a predetermined positional relationship 520 of the facial area 250 to the outline 510. In some embodiments, a neural network is applied to determine the outline 510. Such a neural network may be trained by any suitable technique (e.g., a supervised learning process, an unsupervised learning process, a semi-supervised leaning process, etc.) to determine faces and/or facial areas.

Additionally or alternatively, in some embodiments, the determination the facial area 250 is accomplished by determining at least one facial feature within the facial area 250. The facial feature may be any suitable facial feature, such as nose 530, eyes 540, mouth 550, ear 560, and/or eyebrow 570. In some embodiments, a neural network is applied to determine the facial feature. Such a neural network may be trained by any suitable technique (e.g., a supervised learning process, an unsupervised learning process, a semi-supervised leaning process, etc.) to determine one or more facial features.

In some embodiments, to determine the facial area 250, a predetermined pixel area is applied around a determined location of the facial feature. For example, the facial area may be determined to be a predetermined number of pixels extending horizontally and/or a predetermined number of pixels extending vertically from the location of the facial feature.

In some embodiments, for improved certainty of the facial area 250, the processors executing the application may require that two or more facial features to be found within the image data. In some such examples, to determine the facial area, a predetermined pixel area is applied around any of the facial features. For example, if the two or more facial features include nose 530 and mouth 550, the facial area may be determined to be a predetermined number of pixels extending horizontally and/or a predetermined number of pixels extending vertically from either of the nose 530 or the mouth 550.

In some embodiments, as further illustrated by the example of FIG. 5, the determination of the facial area 250 is accomplished by first determining a non-facial feature associated with a human body 500 within the image data. Examples of the non-facial feature include hand 580, shoulder 582, and leg 584. The facial area 250 may then be determined to be an area positioned at a predetermined positional relationship relative to the non-facial feature. For example, if the non-facial feature comprises the hand 580, the predetermined positional relationship may be a predetermined positional relationship 590 between the hand 580 and the facial area 250.

In some embodiments, the determination of the facial area 250 is accomplished by first determining a bounding box 330 around an object 310, and then analyzing the area outside of the object for the facial area 250. Since the facial area 250 is more likely to be distanced away from the object 310, searching only the area outside of the bounding box for the facial area 250 is likely to be successful; and thus, advantageously, first searching the area outside of the bounding box 330 for the facial area 250 saves computational resources in analyzing the image while not significantly reducing the likelihood of success of the search.

The bounding box 330 may be applied via any suitable technique. For example, the processors executing the anonymizing application 128 may apply a localizer to place the bounding box 330 around object 310 in the image. The localizer may be any suitable algorithm. For example, the localizer may be a neural network. Such a neural network may be trained by any suitable technique (e.g., a supervised learning process, an unsupervised learning process, a semi-supervised leaning process, etc.) to place bounding boxes around objects in images.

Furthermore, in some embodiments, the image data (e.g., pre-anonymized image data) is stored in at least one volatile memory 130 of the imaging device 104 to execute the determination of the facial area 250.

At optional block 425, the system (e.g., via the anonymizing application 128) attempts to identify an indicia 220, 320 in a non-facial area of the image data (e.g., any area of the image data that is not the facial area 250). In some embodiments, the decode module 129 detects the indicia by the decode module 129 being able to decode the indicia. However, it should be noted that the indicia does not necessarily have to be decoded for its presence to be detected (e.g., identified within the image). In some examples, the indicia 220, 320 may be identified by applying a neural network. Such a neural network may be trained by any suitable technique (e.g., a supervised learning process, an unsupervised learning process, a semi-supervised leaning process, etc.) to identify indicia, such as indicia 220, 320.

At optional block 425, the system (e.g., via the anonymizing application 128) may determine if an indicia has been identified. If not, at block 435, the system (e.g., via the anonymizing application 128) may attempt to identify the indicia in an area of the image including both the facial area 250, and the non-facial area. The identification may be done as described above (e.g., by decoding an indicia, by applying a neural network, etc.).

At block 440, the system (e.g., via the anonymizing application 128) produces an anonymized image data by altering pixel data of the facial area 250 of the image data. In some embodiments, the altering the pixel data comprises removing color data of the pixel data, replacing the color data of the pixel data with color data of a predetermined color, and/or changing an intensity of the pixel data.

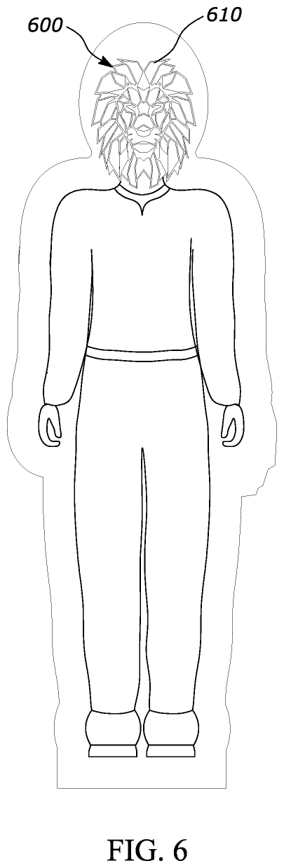

Additionally or alternatively, the altering the pixel data comprises replacing pixel data to create an anonymizing graphic. For instance, the example of FIG. 6 shows an example person 600 whose face has been replaced with an anonymizing graphic of a lion head 610.

Furthermore, in some embodiments, the image data (e.g., pre-anonymized image data) is stored in at least one volatile memory 130 of the imaging device 104 to execute the production of the anonymized image data.

At block 445, the system (e.g., via the anonymizing application 128): (i) stores the anonymized image data in a nonvolatile memory 120 of the imaging device 104, or (ii) transmits the anonymized image data from the imaging device 104 to one or more host processors 108.

In some embodiments, between the capture of the image data (e.g., block 405) and the store or transmit the anonymized image data (e.g., block 445), the image data is not put through at least one of a facial-recognition module or person-recognition module configured to provide information related to an identify of an individual. Furthermore, in some embodiments, the pre-anonymized image data is never stored on the nonvolatile memory 120 of the imaging device 104 (e.g., only the anonymized image data is stored on the nonvolatile memory 120).

In some variations, the example method 400 may be applied to any image stream coming from any of the sensors within the indicia reader 206 or any imaging-based vision device. For example, the example method 400 may be applied to any image stream coming from the imager 702 of the example of FIG. 7. In addition, the example method 400 may be applied selectively to image streams which are likely expected to capture facial data (e.g., from particular devices that have a FOV in a direction that is likely to capture facial data).

In some examples where the imaging device 104 comprises the bi-optic indicia reader 206, the imaging device 104 may include the tower 226 having a tower FOV and the platter 228 having a platter FOV. Here, the example method 400 may be applied a first time to using the tower FOV (e.g., the FOV of block 405 is the tower FOV), and then applied a second time using the platter FOV (e.g., the FOV of block 405 is the platter FOV).

In addition, in some variations, the imaging device 104 comprises a handheld indicia reader, and may be picked up off the countertop or base station, and held in an operator's hand. In this way, items may be slid, swiped past, or presented to a window for the reader to initiate indicia-reading operations. Such an example indicia reader may be moved towards an indicia on a product, and a trigger on the indicia reader may be manually depressed to initiate imaging of the indicia.

Additionally or alternatively, the imaging device 104 may be a freestanding indicia reader, such as a presentation indicia reader standing on a countertop. It should further be appreciated that the image processing characteristics, like the anonymizing features associated with removing facial features prior to storing image data in non-volatile memory, do not need to be limited to machine vision devices like indicia readers, and may be further extended to other imaging devices that can be configured in ways where their respective image data includes facial data.

Additionally, it is to be understood that each of the actions described in the example method 400 may be performed in any order, number of times, or any other suitable combination(s). For example, some or all of the blocks of the example method 400 may be fully performed once or multiple times. In some example implementations, some of the blocks may not be performed while still effecting operations herein.

### ADDITIONAL CONSIDERATIONS

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method, comprising:
capturing, with an indicia reader, an image data of a field of view (FOV) associated with an imager within the indicia reader;
determining, with the indicia reader, a facial area within the image data;
producing, with the indicia reader, an anonymized image data by altering pixel data of the facial area of the image data; and
(i) storing the anonymized image data in a nonvolatile memory of the indicia reader, or (ii) transmitting the anonymized image data from the indicia reader to one or more host processors.

2. The method of claim 1, wherein the altering the pixel data comprises: (i) removing color data of the pixel data, or (ii) replacing the color data of the pixel data with color data of a predetermined color.

3. The method of claim 1, wherein the altering the pixel data comprises: (i) changing an intensity of the pixel data, or (ii) replacing pixel data to create an anonymizing graphic.

4. The method of claim 1, wherein the determining the facial area comprises determining at least one facial feature within the facial area.

5. The method of claim 4, wherein between the capturing of the image data and the storing or transmitting the anonymized image data, the image data is not put through at least one of a facial-recognition module or person-recognition module configured to provide information related to an identify of an individual.

6. The method of claim 4, wherein the determining the facial area comprises applying a predetermined pixel area around a determined location of the at least one facial feature.

7. The method of claim 1, wherein the determining the facial area comprises determining an outline of a person within the image data, and determining the facial area based on a predetermined positional relationship of the facial area to the outline.

8. The method of claim 1, wherein the determining the facial area comprises determining a non-facial feature associated with a human body within the image data, and determining the facial area to be an area positioned at a predetermined positional relationship relative to the non-facial feature.

9. The method of claim 1, wherein the determining the facial area comprises: (i) applying a localizer comprising a neural network to impose a bounding box surrounding an object in the image data, and (ii) analyzing a portion of the image data outside of the bounding box to determine the facial area.

10. The method of claim 1, wherein the image data is: (i) pre-anonymized image data received from the imager within the indicia reader, and (ii) not stored on the nonvolatile memory of the indicia reader.

11. The method of claim 1, further comprising storing the image data in at least one volatile memory of the indicia reader to execute the determining the facial area and the producing the anonymized image data.

12. An imaging engine, the imaging engine comprising one or more processors configured to:
capture an image data of the FOV;
determine a facial area within the image data;
produce an anonymized image data by altering pixel data of the facial area of the image data; and
(i) store the anonymized image data in a nonvolatile memory of the indicia reader, or (ii) transmit the anonymized image data from the indicia reader to one or more host processors.

13. The imaging engine of claim 12, wherein the altering the pixel data comprises: (i) removing color data of the pixel data, or (ii) replacing the color data of the pixel data with color data of a predetermined color.

14. The imaging engine of claim 12, wherein the altering the pixel data comprises: (i) changing an intensity of the pixel data, or (ii) replacing pixel data to create an anonymizing graphic.

15. The imaging engine of claim 12, wherein the determine the facial area comprises determining at least one facial feature within the facial area.

16. The imaging engine of claim 15, wherein the one or more processors are further configured to:
between the capture of the image data and the store or transmit the anonymized image data, not put the image data through at least one of a facial-recognition module or person-recognition module configured to provide information related to an identify of an individual.

17. The imaging engine of claim 15, wherein the determine the facial area comprises applying a predetermined pixel area around a determined location of the at least one facial feature.

18. The imaging engine of claim 12, wherein the determine the facial area comprises determining an outline of a person within the image data, and determining the facial area based on a predetermined positional relationship of the facial area to the outline.

19. The imaging engine of claim 12, wherein the determine the facial area comprises determining a non-facial feature associated with a human body within the image data, and determining the facial area to be an area positioned at a predetermined positional relationship relative to the non-facial feature.

20. The imaging engine of claim 12, wherein the determine the facial area comprises: (i) applying a localizer comprising a neural network to impose a bounding box surrounding an object in the image data, and (ii) analyzing a portion of the image data outside of the bounding box to determine the facial area.

21. The imaging engine of claim 12, wherein (i): the image data is pre-anonymized image data received from the imager within the indicia reader, and (ii) the one or more processors are further configured to not store the pre-anonymized image data on the nonvolatile memory of the indicia reader.

22. The imaging engine of claim 12, wherein the one or more processors are further configured to store the image data in at least one volatile memory of the indicia reader to execute the determine the facial area and the produce the anonymized image data.

23. An indicia reader, comprising:
an imaging assembly configured to capture image data of an environment appearing in a field of view (FOV);
a housing including a tower, a platter, and the imaging assembly; and
a non-transitory computer-readable media storing machine-readable instructions that, when executed, cause the indicia reader to:
capture an image data of the FOV;
determine a facial area within the image data;
produce an anonymized image data by altering pixel data of the facial area of the image data; and
(i) store the anonymized image data in a nonvolatile memory of the indicia reader, or (ii) transmit the anonymized image data from the indicia reader to one or more host processors.

24. The indicia reader of claim 23, wherein the machine-readable instructions, when executed, further cause the indicia reader to:
receive a disable anonymizer feature command; and
responsive to receiving the disable anonymizer feature command, enable:
(i) storing of the image data in the nonvolatile memory of the indicia reader, or
(ii) transmission of the image data from the indicia reader to the one or more host processors.

25. The indicia reader of claim 23, wherein the machine-readable instructions, when executed, further cause the indicia reader to:
prior to the produce of the anonymized image data, attempt to identify an indicia in a non-facial area of the image data; and
if the indicia is not identified in the non-facial area, attempt to identify the indicia in an area of the image data including both the non-facial area and the facial area.

26. The indicia reader of claim 23, wherein:
the FOV is a tower FOV extending horizontally from the tower, and the imaging assembly is further configured to capture a platter FOV extending vertically from the platter; and
the machine-readable instructions, when executed, further cause the indicia reader to:
capture platter image data of the platter FOV;
determine a facial area within the platter image data;
produce an anonymized platter image data by altering pixel data of the facial area of the platter image data; and
(i) store the anonymized platter image data in a nonvolatile memory of the indicia reader, or (ii) transmit the anonymized platter image data from the indicia reader to the one or more host processors.

27. The indicia reader of claim 23, wherein the altering the pixel data comprises: (i) removing color data of the pixel data, or (ii) replacing the color data of the pixel data with color data of a predetermined color.

28. The indicia reader of claim 23, wherein the altering the pixel data comprises: (i) changing an intensity of the pixel data, or (ii) replacing pixel data to create an anonymizing graphic.

29. The indicia reader of claim 23, wherein the determine the facial area comprises determining at least one facial feature within the facial area.

30. The indicia reader of claim 29, wherein the machine-readable instructions, when executed, further cause the indicia reader to:
between the capture of the image data and the store or transmit the anonymized image data, not put the image data through at least one of a facial-recognition module or person-recognition module configured to provide information related to an identify of an individual.

31. The indicia reader of claim 29, wherein the determine the facial area comprises applying a predetermined pixel area around a determined location of the at least one facial feature.

32. The indicia reader of claim 23, wherein the determine the facial area comprises determining an outline of a person within the image data, and determining the facial area based on a predetermined positional relationship of the facial area to the outline.

33. The indicia reader of claim 23, wherein the determine the facial area comprises determining a non-facial feature associated with a human body within the image data, and determining the facial area to be an area positioned at a predetermined positional relationship relative to the non-facial feature.

34. The indicia reader of claim 23, wherein the determine the facial area comprises: (i) applying a localizer comprising a neural network to impose a bounding box surrounding an object in the image data, and (ii) analyzing a portion of the image data outside of the bounding box to determine the facial area.

35. The indicia reader of claim 23, wherein (i): the image data is pre-anonymized image data received from the imager within the indicia reader, and (ii) the machine-readable instructions, when executed, further cause the indicia reader to not store the pre-anonymized image data on the nonvolatile memory of the indicia reader.

36. The indicia reader of claim 23, wherein the machine-readable instructions, when executed, further cause the indicia reader to store the image data in at least one volatile memory of the indicia reader to execute the determine the facial area and the produce the anonymized image data.
